(19) United States
(12) Patent Application Publication
(10) Pub. No.: US 2025/0313478 A1
(43) Pub. Date: Oct. 9, 2025

(54) SILICON CARBIDE GRIT AND METHOD FOR PRODUCING SAME

(71) Applicants: FRAUNHOFER-GESELLSCHAFT ZUR FÖRDERUNG DER ANGEWANDTEN FORSCHUNG E.V., München (DE); ESK-SIC GmbH, Frechen (DE)

(72) Inventors: Jörg ADLER, Meißen (DE); Axel BALES, Dresden (DE); Hans-Peter MARTIN, Freital (DE); Jan RÄTHEL, Dresden (DE); Matthias HAUSMANN, Frechen (DE); Jörg DEUTMARG, Frechen (DE); Stefan WILD, Frechen (DE); Yvonne WOLFF, Frechen (DE)

(73) Assignees: FRAUNHOFER-GESELLSCHAFT ZUR FÖRDERUNG DER ANGEWANDTEN FORSCHUNG E.V., München (DE); ESK-SIC GmbH, Frechen (DE)

(21) Appl. No.: 18/864,171

(22) PCT Filed: May 8, 2023
(86) PCT No.: PCT/EP2023/062135

§ 371 Date: Nov. 8, 2024

(30) Foreign Application Priority Data
May 9, 2022 (DE) 10 2022 111 456.2

(51) Int. Cl. C01B 32/956; B09B 3/30; B09B 3/40; B09B 101/60

(52) U.S. Cl. CPC C01B 32/956; B09B 3/30; B09B 3/40; B09B 2101/60; C01P 2004/32; C01P 2004/61; C01P 2006/10

(57) ABSTRACT

A silicon carbide gravel usable, for example, for refractory products, and a method for the production of different qualities and grain sizes of silicon carbide gravel. The silicon carbide gravel includes SiC particles having a high density. Particles of the silicon carbide gravel consist to an extent of at least 85 mass % of SiC waste products and have a density of 2.89 to 3.20 g/cm3, a compressive strength of >2500 MPa, a fraction of <5% of pores with an equivalent diameter of >100 μm and a fraction of open porosity of <10%. The silicon carbide gravel consists at least predominantly of particles with particle sizes of greater than or equal to 2 mm and the particles have an irregular shape produced by a mechanical loading.

The invention relates to the field of Technical Ceramics and concerns silicon carbide gravel, which may be used, for example, for refractory products, and a method for the production of silicon carbide gravel, which may be used for the production of various qualities and grain sizes of silicon carbide gravel.

Silicon carbide (SiC) is a synthetic industrial mineral that is used in many industrial sectors due to its outstanding properties (hardness, high temperature properties, chemical resistance). Of particular importance is its use in the form of fractionated micro fine powder grain sizes (0.5 to approximately 250 μm) in microelectronics/photovoltaics (wafer saws), for the production of Technical Ceramics (mechanical seals, ballistic protective ceramics for military technology), automotive/environmental technology (diesel particulate filters), as an abrasive material for high-quality surface machining throughout mechanical engineering, as well as a component in refractory materials for the lining of waste incineration systems.

The production of raw SiC is carried out via the electrosynthesis process, the so-called Acheson process (DE 76629 A, DE 85197 A), which has been used for about 100 years, in which SiC is synthesized in an electric furnace by means of a carbothermic reduction of SiO₂ (quartz sand) with carbon (usually petroleum coke). This method is clearly tied to the price of electricity and oil (raw material petroleum coke) and also causes relatively high environmental costs (due to high dust, CO/CO₂ and SO₂ emissions).

Despite many attempts, alternative manufacturing methods have not been successful for economic reasons, and will not be available in the foreseeable future.

After SiC production, the desired SiC powder grain sizes are produced from the raw SiC by grinding, cleaning and fractionation.

An increase in demand for the grain sizes therefore always currently requires an increase in raw SiC production, which leads to a further increase in the raw capacity and thus to structural scarcity and price inelasticity.

Although SiC is considered a globally available bulk raw material, there have been shortages and price increases for the strategically important high-quality grains (HQ) for years. But an even greater problem with special grain sizes is that large quantities of individual grain size ranges are required in high-tech applications. Both lead to price premiums and supply bottlenecks for these special grain sizes due to the above-mentioned price inelasticity relationships.

The fractionation of the SiC powders, in particular, the F4 to F220 grain sizes, is usually checked by means of sieving methods according to the FEPA standard 42-1:2006 or ISO 8486, and by means of test sieves. The coarsest SiC powder grain currently available according to these standards is an F4 grain size, also called macro grain, which has an average particle size of approximately 4.8 mm.

Coarser fractions of SiC powders are not available on the market.

Numerous semi-finished products and finished products are made from the raw SiC.

According to DD 300 288 A7, abrasion-resistant ceramic grinding balls and a method for their production basis on Si₃N₄ and SiC are known. For example, the grinding balls are formed from very fine SiC powder mixtures with particle sizes <1 μm, produced by pressing or build-up granulation and then sintered into SiC ceramics. They have densities of 2.93-3.11 g/cm3.

As intended, these grinding balls have a high roundness of >0.95. The roundness is defined and measured in accordance with DIN-ISO 13322 Parts 1 and 2.

In the production of SiC products, various SiC waste is created, such as so-called SiC sintering scrap or other production-related SiC waste. But even after the products have been used and their service life has expired, or after the products have failed, SiC waste remains, such as grinding sludge or used kiln furniture, or used SiC diesel particle filters.

Various methods are already known for the recycling of SiC products.

According to DE 10 2013 218 450 A1, a method for recycling powdered SiC waste products is known, in which powdered SiC waste products, which have at least 50% by mass SiC and an average particle size d₅₀ between 0.5 and 500 μm, are subjected to a temperature treatment under vacuum or oxygen-free atmosphere at temperatures of at least 2000° C.

This causes the SiC particles to become coarser again to a few mm and may therefore be used again for a host of applications in which they would otherwise not have been usable due to the particle size being too small.

Furthermore, according to DE 10 2020 102 512.2 A1, a method for separating impurities of silicon carbide is known, in which powdered SiC waste products, which have at least 50% by mass of SiC and an average particle size d50 between 0.5 to 1000 μm, and have been subjected to a temperature treatment under vacuum or non-oxidizing atmosphere at temperatures of 1400-2600° C. and have been cooled down, [sic: are] then mechanically treated and physically separated into two fractions, of which the mass of impurities in one fraction is at least higher by a factor of 2 than in the other fraction.

The disadvantage of the known methods for recycling products with SiC is that only a few specific SiC waste products have been recycled so far.

The object of the present invention is to specify silicon carbide gravel, in which the SiC particles have a high density, and, furthermore, to specify a simple and cost-effective method for the production of silicon carbide gravel.

The object is achieved by the invention specified in the claims. Advantageous embodiments are the subject of the dependent claims, wherein the invention also includes combinations of the individual claims in the sense of an “and” connection, as long as they do not exclude each other.

The silicon carbide gravel according to the invention, whose particles consist of at least 85% by mass of silicon carbide from SiC waste products and have a density of 2.89 to 3.20 g/cm3, a compressive strength of >2500 MPa, a fraction of <5% of pores with an equivalent diameter of >100 μm, and a fraction of open porosity of <10%, consists at least predominantly of particles with particle sizes greater than or equal to 2 mm, and the particles have an irregular shape with a roundness of 0.5 to 0.8 produced by a mechanical loading with an energy input of between 0.1 and 5 MJ/kg.

Advantageously, waste products from the Acheson process or SiC sintering scrap or production-related SiC waste from the manufacture of the product are present as SiC waste products, [sic] whose particles, which consist of at least 85% by mass of silicon carbide and have a density of 2.89 to 3.20 g/cm3, a compressive strength of >2500 MPa, a proportion of <5% of pores with an equivalent diameter of >100 μm and a fraction of open porosity of <10%, wherein the particles have at least predominantly particle sizes of greater than or equal to 2 mm and the particles have an irregular shape with a roundness of 0.5 to 0.8 produced by a mechanical loading with an energy input of between 0.1 and 5 MJ/kg, wherein more advantageously, present as SiC waste products are those products made of SSiC, LPS-SiC, SiSiC, RSIC, NSiC and/or OBSiC ceramics and/or fiber composites made of C-SiC and/or SiC-SiC.

Furthermore, advantageously, the silicon carbide gravel according to the invention consists at least 90% by mass, advantageously 95% by mass, and more advantageously 98% by mass of silicon carbide.

Also advantageously, the particles of the silicon carbide according to the invention also have a density of 3.05 to 3.20 g/cm3.

And also advantageously, the silicon carbide gravel according to the invention consists of at least predominantly, advantageously at least 85%, more advantageously at least 95% of particles with a particle size greater than or equal to 2 mm.

It is also advantageous if the particle sizes of the silicon carbide gravel according to the invention are greater than or equal to 2 mm to 20 mm, or 5 mm to 63 mm.

It is furthermore advantageous if the particle shapes of the silicon carbide gravel according to the invention, which are achieved after a mechanical loading of the SiC waste products by applying a mechanical impulse, are produced by mixing, milling, or more advantageously, by autogenous milling, or by the use of eddy currents and/or ultrasound, or by grinding, hammering, breaking, or using electrical discharges or shockwaves.

It is also advantageous if the silicon carbide gravel according to the invention has irregular, completely and/or partially sharp-edged and/or irregular, partially and/or entirely rounded particle shapes.

In the method according to the invention for the production of silicon carbide gravel, SiC waste products are processed by a mechanical loading with an energy input between 0.1 and 5 MJ/kg into SiC particles, which consist of at least 85% by mass of silicon carbide and have a density of 2.89 to 3.20 g/cm3, a compressive strength of >2500 MPa, a fraction of <5% of pores with an equivalent diameter of >100 μm, and a fraction of open porosity of <10%, and with particle sizes greater than or equal to 2 mm and an irregular shape with a roundness of 0.5 to 0.8,
or SiC waste products are processed before and/or after a temperature treatment under vacuum or non-oxidizing atmosphere at temperatures of 1400 to 2600° C. by means of a mechanical loading with an energy input between 0.1 and 5 MJ/kg into SiC particles, which consist of at least 85% by mass of silicon carbide and have a density of 2.89 to 3.20 g/cm3, a compressive strength of >2500 MPa, a fraction of <5% of pores with an equivalent diameter of >100 μm, and a fraction of open porosity of <10%, and with particle sizes greater than or equal to 2 mm and an irregular shape with a roundness of 0.5 to 0.8,
or SiC waste products are processed before and/or after a temperature treatment under vacuum or non-oxidizing atmosphere at temperatures of 1400 to 2600° C. by means of a mechanical loading with an energy input between 0.1 and 5 MJ/kg into SiC particles, which consist of at least 85% by mass of silicon carbide and have a density of 2.89 to 3.20 g/cm3, a compressive strength of >2500 MPa, a fraction of <5% of pores with an equivalent diameter of >100 μm and a fraction of open porosity of <10%, and with particle sizes greater than or equal to 2 mm and an irregular shape with a roundness of 0.5 to 0.8, wherein such particles may be mechanically treated again, and at the same time or thereafter physically separated into two fractions, of which the mass of impurities in one fraction is at least higher by a factor of 2 than in the other fraction.

Advantageously, a physical separation of the SiC particles into fractions is carried out at least after one or the last treatment under mechanical loading of the SiC particles.

Furthermore, advantageously, SiC waste products are subjected to a temperature treatment under vacuum or non-oxidizing atmosphere at temperatures of 1400 to 2600° C., followed by a treatment under mechanical loading, and then a physical separation of the SiC particles into fractions.

Also advantageously, SiC waste products with a density of 3.05 to 3.20 g/cm3 are used.

And also advantageously, the mechanical loading of the SiC waste products is achieved by applying a mechanical impulse, advantageously, by mixing, grinding, and more advantageously, by autogenous grinding, or by using eddy currents and/or ultrasound or by means of grinding, hammering, breaking, or electrical discharges or shock waves.

It is also advantageous if particles with particle sizes greater than or equal to 2 mm to 20 mm, or 5 mm to 63 mm, are achieved.

Furthermore, it is advantageous if a temperature treatment is carried out at temperatures between 2000° C. and 2600° C.

And it is also advantageous if a temperature treatment is carried out under an argon or nitrogen atmosphere.

It is also advantageous if a temperature treatment is carried out at temperatures of at least 2000° C. between 10 and 300 min.

And it is also advantageous if the physical separation of the particles is carried out after the temperature treatment according to the particle size, the particle shape, the density and/or the physical and/or chemical surface properties of the particles.

It is also advantageous if the separation according to the particle size and/or the particle shape is carried out by sieving, sifting and/or cyclone methods, or the separation is carried out by the action of mass forces with respect to the particle density by means of flotation, sedimentation, sifting, centrifugation and/or cyclone methods, or the separation according to the density of the particles is carried out by flotation and/or cyclone methods.

According to the invention, the silicon carbide gravel according to the invention is used for the production of SiC-containing ceramics, in particular, refractory ceramics.

With the solution according to the invention, it is possible for the first time to specify silicon carbide gravel whose particles have a high mechanical strength, and furthermore, to specify a simple and cost-effective method for the production of silicon carbide gravel.

This is achieved by silicon carbide gravel, consisting of particles, which consist at least 85% by mass of silicon carbide from SiC waste products, and have a density of 2.89 to 3.20 g/cm3, a compressive strength of >2500 MPa, a fraction of <5% of pores with an equivalent diameter of >100 μm and a fraction of open porosity of <10%.

Gravel is a designation for a grain size and for an unconsolidated sediment.

The grain size for gravel is specified according to DIN 4022 and DIN EN ISO 14668 with a grain diameter between 2 mm and 63 mm. At the same time, a distinction is also made between coarse gravel with particle sizes of 20-63 mm, between medium gravel with particle sizes of 6.3 and 20 mm, and between fine gravel with particle sizes of 2 and 6.3 mm (Wikipedia, keyword Kies [gravel]).

Gravel as unconsolidated sediment, or unconsolidated rock, is a consolidated heap with little grain binding (Wikipedia, keyword unconsolidated sediment)

Within the scope of the present invention, the term silicon carbide gravel is to be understood, with respect to particle size, as SiC particles with grain diameters of greater than or equal to 2 mm up to 63 mm.

The SiC particles according to the invention are irregularly shaped due to a mechanical loading with an energy input between 0.1 and 5 MJ/kg, but have predominantly convex surfaces. With known grain shape analyzers, average roundness in the range of 0.5 to 0.8 is measured.

The grain size, grain shape and roundness are defined and measured in accordance with DIN-ISO 13322 Parts 1 and 2.

Advantageously, the silicon carbide gravel according to the invention consists of particles with at least 85% by mass, advantageously 90% by mass, more advantageously 95% by mass, and more advantageously 98% by mass of silicon carbide from SiC waste products.

According to the invention, it is of particular importance that the particles are produced from, and consist of, mainly silicon carbide of the silicon carbide gravel according to the invention made of SiC waste products.

Within the scope of the present invention, SiC waste products are to be understood to be SiC products that come about in the production of the raw SiC or originate from semi-finished products and finished products made of SiC that were originally produced and sintered and processed into molded bodies. SiC waste products used according to the invention are also products that accumulate as waste during the production of SiC semi-finished products and finished products from SiC, if the material exhibits cracks, deformations or poor dimensional stability or other defects and is sorted out as rejects, and is then so-called SiC sintering scrap. However, SiC waste, such as used kiln furniture, or used SiC diesel particulate filters, are also present after the use of the products and after their service life has elapsed or after failure or destruction of the products.

Furthermore, within the scope of the present invention, SiC waste products are always to be understood as lumpy SiC waste products which are processed to the particle size desired for SiC gravel, advantageously, crushed by mechanical loading.

In any case, the SiC waste products according to the invention do not concern those SiC waste products that require particle growth to make the particle size of the SiC waste products coarser, in order to achieve the particle size desired for SiC gravel. This concerns, for example, SiC waste products with particle sizes of less than 2 mm, such as SiC powders, SiC slurries or SiC dusts.

With the solution according to the invention, no grain growth is achieved, but a chemical conversion of the SiC waste products in order to achieve a higher SiC content, as well as a reduction of the open porosity and/or the achievement of a specific grain shape with regard to the roundness.

According to the invention, all such SiC products may be used as SiC waste products.

The particles of the silicon carbide gravel have a density of 2.89 to 3.20 g/cm3. Advantageously, the particles of the silicon carbide gravel according to the invention have a density of 3.05 to 3.20 g/cm3, measured via pycnometric methods.

Furthermore, the SiC particles of the silicon carbide gravel according to the invention have a very high compressive strength of >2500 MPa due to the very low content of <5% of coarse pores with an equivalent diameter of >100 μm, which comminuted raw SiC from the Acheson process does not achieve.

The determination of the grain size and grain shape may be carried out in accordance with DIN-ISO 13322 Parts 1 and 2 (static and dynamic analysis).

The grain strength may be determined according to the ASTM D5731-16 method (Standard Test Method for Determination of the Point Load Strength Index of Rock and Application to Rock Strength Classifications) or the analogous methodology according to the “ISRM—International Society for Rock Mechanics 2007. Rock characterization testing & monitoring—ISRM suggested methods. Ed. E. T. Brown, Pergamon Press, London, 211p.” according to the test specimen shape/dimension d) “irregular lump”. The reference to the breaking force is made by determining an equivalent diameter.

These methods may be used equivalently for SiC particles according to the invention.

The strength is variable-standardized according to the aforementioned methods and indicated as “point load strength index” Iₛ₍50) in MPa. Using a correlation method, a compressive strength σ_{c} in MPa may be calculated from this.

The compressive strength of the SiC gravel particles determined in this manner is >2500 MPa, while coarse SiC particles broken from Acheson raw material have compressive strengths of significantly less than 1000 MPa due to their high degree of fissuring and porosity.

Therefore, the use of such raw SiC as a raw material for various applications, e.g., as a refractory product, is also out of the question, because, due to the high degree of fissuring and porosity of the SiC particles, a high quality of such refractory products cannot be achieved with regard to strength and durability. SiC ceramic bodies, such as grinding balls, which are specifically manufactured from special powders by means of a ceramic manufacturing process, however, do not achieve the required packing density of the SiC particles and are also not used due to the high price due stemming from the complex production.

It is of particular importance that the SiC particles according to the invention have only very few large pores with an equivalent diameter of >100 μm. These pores are irregularly shaped cavities in the structure and are determined by means of image analysis methods on polished sections. The equivalent diameter of the same area is determined here as the size specification. The quantity of such pores is stated as a percentage according to the area portion determined by image analysis, which may be specified as volume percentage in percent using stereological laws. However, it is also possible to produce more complex, so-called micro-X-ray computed tomography images of the particles of the gravel and similarly arrive at a determination of the size and volume fraction of the large pores with an equivalent diameter of >100 μm.

Furthermore, advantageously, the particles of the gravel according to the invention have a very low open porosity of <10%. Within the scope of the present invention, these pores comprise all pores, cavities and cracks in the SiC particles that are accessible from the surface.

The open porosity is known to be measured by liquid or gas pycnometry or mercury porosimetry.

Advantageously, the SiC waste products according to the invention may be products made of SSiC, LPS-SiC, SiSiC, RSiC, NSiC and/or OBSiC ceramic and/or fiber composite from C-SiC and/or SiC-SiC. The abbreviations and designations listed for the various SiC ceramics are familiar to the person skilled in the art and may be found, for example, in the Brevier Technische Keramik (Brevier Technische Keramik: published by the Association of the Ceramics Industry, 4th edition 2004, ISBN: 9783924158361). Waste from mineral concretes containing high SiC content, also known as mineral casting, may be advantageous SiC waste products. SiC mineral concretes consist of SiC particles in a polymer matrix, mostly made from polyester resins.

When selecting the SiC waste products used according to the invention, it is also possible to carry out a pre-sorting according to their composition prior to use in the methods according to the invention. As a result, a silicon carbide gravel according to the invention of the high purity and quality may be achieved.

If SSiC waste products are used, usually no additives have to be added during the production of the silicon carbide gravel according to the invention, and silicon carbide gravel with particle sizes greater than or equal to 2 mm of high purity >99% and with a freedom from pores of almost 100% is achieved.

For LPS SiC waste products, no additives have to be added during the production of silicon carbide gravel according to the invention, and silicon carbide gravel with particle sizes greater than or equal to 2 mm of high purity >90% and with a freedom from pores of almost 100% is achieved.

For SiSiC waste products, the free Si content is quantitatively determined using known methods and a corresponding quantity of carbon-containing additives is added to the waste products in order to achieve a stoichiometric conversion of the Si+C to SiC. The optimal quantity may be determined by a simple test series by a person skilled in the art. A silicon carbide gravel with particle sizes greater than or equal to 2 mm of high purity >98% and with a content of <5% of pores with an equivalent diameter of >100 μm is achieved.

For RSiC waste products, 2-20% of fine SiC powder of a particle size of 0.2-10 μm is added and a silicon carbide gravel with particle sizes greater than or equal to 2 mm of high purity >99% with a content <5% of pores with an equivalent diameter of >100 μm is achieved. By adding the fine SiC powder, the open porosity of the RSiC particles is closed during the thermal treatment. The optimal quantity and particle size of the added fine SiC particles may be determined with a simple test series by the person skilled in the art until a quantity of open porosity of <10% has been achieved.

For NSiC waste products, including SiON, SiAlON, Si₃N₄-containing and similar nitride-bound SiC waste products, the oxide content is primarily determined and a corresponding quantity of carbon-containing additives is added to achieve a reduction in the oxides. The optimal quantity may be determined by a simple test series by a person skilled in the art. A silicon carbide gravel with particle sizes greater than or equal to 2 mm with an SiC content >85% with a content <5% of pores with an equivalent diameter of >100 μm is achieved.

For OBSiC waste products, under which SiO₂ and SiC waste products bound with aluminosilicate are included, the oxide content is primarily determined and a corresponding quantity of carbon-containing additives are added to achieve a reduction of the oxides. The optimal quantity may be determined by a simple test series by a person skilled in the art. A silicon carbide gravel with particle sizes greater than or equal to 2 mm of high purity >85% with a content <5% of pores with an equivalent diameter of >100 μm is achieved.

If C-SiC waste products, i.e., waste from carbon fiber-reinforced SiC composites, such as short or long fiber-reinforced materials, or composites produced via silicification or precursor infiltration, are used, the free Si and C fractions must be analyzed during the production of the silicon carbide gravel according to the invention and a corresponding quantity of Si or C additives must be used to produce a stoichiometric composition. As C-SiC waste products usually have a significantly higher C content than a free Si content, Si additives usually have to be added in order to convert the excess carbon to SiC. The addition takes place in the required amount that is necessary to adjust a stoichiometric composition to the SiC. The optimum quantity may be determined by simple test series by the person skilled in the art, and silicon carbide gravel with particle sizes larger than 1 mm of high purity >95% with a content <5% of pores with an equivalent diameter of >100 μm is achieved.

If SiC-SiC waste products, i.e., waste from silicon carbide fiber-reinforced SiC composites, are used, 2-20% of fine SiC powders with a grain size of 0.5-5 μm are added and a silicon carbide gravel with particle sizes >1 mm of high purity >99% with a content <5% of pores with an equivalent diameter of >100 μm is achieved. By adding the fine SiC powder, the open porosity of the SiC-SiC particles is closed during the thermal treatment. The optimal quantity and particle size of the added fine SiC particles may be determined with a simple test series by the person skilled in the art until a quantity of open porosity of <10% has been achieved.

For SiC mineral concrete waste products, a temperature treatment is first carried out at 600-1000° C. under absence of air (pyrolysis) and then the carbon content is quantitatively determined using known methods and a corresponding quantity of silicon-containing additives is added to the waste products to achieve a stoichiometric conversion of the Si+C to SiC. The optimal quantity may be determined by a simple test series by a person skilled in the art. A silicon carbide gravel with particle sizes greater than or equal to 2 mm of high purity >98% and with a content of <5% of pores with an equivalent diameter of >100 μm is achieved.

For coarse waste products from raw SiC production, 5-20% of fine SiC powder of a particle size of 0.2-10 μm is added and a silicon carbide gravel with particle sizes greater than or equal to 2 mm of high purity >99% with a content <5% of pores with an equivalent diameter of >100 μm is achieved. By adding the fine SiC powder, the open porosity of the SiC particles of the raw SiC is closed during the thermal treatment. The optimal quantity and particle size of the added fine SiC particles may be determined with a simple test series by the person skilled in the art until a quantity of open porosity of <10% has been achieved.

Very advantageously, mixtures of the waste products mentioned may also be used, especially if by doing so, the type and quantity of additives required is reduced. Accordingly, it is, e.g., advantageous to produce mixtures of SiSiC waste products with C-SiC and/or pyrolyzed SiC mineral concrete waste products and then treat them thermally. The components are then mixed according to the analyzed free Si and C contents in order to add as few or no further C or Si-containing additives as possible. This way, from mixtures of the various SiC waste products, a silicon carbide gravel with particle sizes greater than or equal to 2 mm with purity >85% SiC and with a content <5% of pores with an equivalent diameter of >100 μm is achieved.

Furthermore, it is of particular importance according to the invention that the SiC waste products have been subjected to a mechanical loading with an energy input between 0.1 and 5 MJ/kg and then have at least predominantly particle sizes of greater than or equal to 2 mm and an irregular shape produced by a mechanical loading with a roundness of 0.5 to 0.8. Here, the mechanical loading may occur either before the thermal treatment or also after the thermal treatment, or also before and after the thermal treatment.

Due to the treatment of the SiC waste products with a mechanical loading, products with a wide particle size range are created. Therefore, in order to produce the silicon carbide gravel according to the invention, a physical separation into various fractions is required in most cases, wherein through the mechanical loading processes, the yield of particles with particle sizes greater than or equal to 2 mm is at least 50%, usually 80 to 95%.

This is a significant difference to the raw SiC, which is present after the Acheson process, and in which the SiC crystals may also have sizes up to the mm range. However, these SiC crystals are heavily fissured and intergrown and have significantly more than 5% of coarse pores in the range of several hundred micrometers up to the millimeter range of the equivalent diameter.

Due to this structure of the macro grain size of the raw SiC, its mechanical strength is very low, such that application thereof is very limited or not possible. Such macro grain sizes cannot be used as abrasives, because they would break very easily and they cannot be used in applications that are subjected to a chemical, in particular, oxidative attack, or an attack by aggressive media or atmospheres since their large porosity provides a large surface for attack and destruction of the material.

The particles of the silicon carbide gravel according to the invention have no or ≤5% of pores with an equivalent diameter of greater than 100 μm.

With the silicon carbide gravel according to the invention, SiC is present, which [sic], due to its raw materials as SiC waste products and due to the mechanical loading in a macro grain size of particles with particle sizes greater than or equal to 2 mm, which do not have the disadvantages of the macro grain size from raw SiC.

Advantageously, the silicon carbide gravel according to the invention consists at least predominantly, advantageously at least 85%, more advantageously at least 95%, of particles with a particle size greater than or equal to 2 mm.

Furthermore, advantageously, the silicon carbide gravel according to the invention is present in particle sizes between greater than or equal to 2 mm to 20 mm, or 5 mm to 63 mm. Likewise, the silicon carbide gravel according to the invention differs from silicon carbide products with dimensions greater than or equal to 2 mm in that the silicon carbide gravel according to the invention consists of particles having an irregular shape produced by a mechanical loading.

The produced irregular shape with a roundness of 0.5 to 0.8 of the silicon carbide gravel according to the invention [sic: is] available after a mechanical loading of the SiC waste products with an energy input of between 0.1 and 5 MJ/kg by applying a mechanical impulse, more advantageously by autogenous mixing, or by the use of eddy currents and/or by ultrasound, or by grinding, hammering, breaking or by means of electrical discharges or shock waves, for example, by means of electric pulse fragmentation or pulsed power processing.

Advantageously, the particles may be in the form of irregular, completely and/or partially sharp-edged and/or irregular, completely or partially rounded shapes.

The irregularity according to the invention relates to SiC particles, which have an irregular shape and a roundness of 0.5 to 0.8. The irregularity relates to the shape that, according to the invention, should not correspond to a geometric shape, such as balls, cylinders, cubes, cuboids, pyramids, cones, pyramid or truncated cones.

Furthermore, the silicon carbide gravel according to the invention has only a low impurity content, because the starting materials, the SiC waste products, as a rule, have a high purity of SiC. Impurities that are still contained nonetheless, especially metallic impurities, or impurities that are introduced by the mechanical loading, may also be reduced or eliminated after the application of known methods for removing impurities.

In the method according to the invention for the production of silicon carbide gravel, SiC waste products are processed by means of mechanical loading into SiC particles consisting of at least 85% by mass of silicon carbide and have a density of 2.89 to 3.20 g/cm3, a compressive strength of >2500 MPa, a fraction of <5% of pores with an equivalent diameter of >100 μm and a fraction of open porosity of <10%, with particle sizes greater than or equal to 2 mm and an irregular shape, wherein a physical separation into various particle fractions may take place before and/or after the mechanical loading.

Alternatively, silicon carbide gravel is produced according to the invention by SiC waste products being processed into SiC particles before and/or after a temperature treatment under vacuum or non-oxidizing atmosphere at temperatures of 1400 to 2600° C. by means of a mechanical loading of SiC particles, which consist of at least 85% by mass silicon carbide and have a density of 2.89 to 3.20 g/cm3, a compressive strength of >2500 MPa, a fraction of <5% of pores with an equivalent diameter of >100 μm and a fraction of open porosity of <10%, and with particle sizes greater than or equal to 2 mm and an irregular shape.

Even according to this alternative method, a physical separation into various particle fractions may take place both before and after the mechanical loading.

Another alternative method according to the invention for the production of silicon carbide gravel consists of SiC waste products being processed into SiC particles, before and/or after a temperature treatment under vacuum or non-oxidizing atmosphere at temperatures of 1400 to 2600° C. by means of a mechanical loading, which consist of at least 85% by mass of silicon carbide and have a density of 2.89 to 3.20 g/cm3, a compressive strength of >2500 MPa, a fraction of <5% of pores with an equivalent diameter of >100 μm, and a fraction of open porosity of <10%, and with particle sizes greater than or equal to 2 mm and an irregular shape, wherein such particles may be mechanically treated again subsequently, and at the same time and or thereafter are physically separated into two fractions, of which the mass of impurities in one fraction is at least higher by a factor of 2 than in the other fraction. In accordance with the other alternative production methods according to the invention, a physical separation into various particle fractions may occur both before and after the mechanical loading.

Advantageously, for all method alternatives according to the invention for the production of silicon carbide gravel, SiC waste products with a density of 3.05 to 3.20 g/cm3 are used.

Advantageously, for all method alternatives according to the invention for the production of silicon carbide gravel, the mechanical loading of the SiC waste products with an energy input between 0.1 and 5 MJ/kg is achieved likewise by applying a mechanical impulse, more advantageously by mixing, milling, such as by autogenous grinding, or more advantageously through the use of eddy currents and/or ultrasound or by means of milling, hammering, breaking or by means of electrical discharges and shock waves.

Advantageously, with the method variants according to the invention, SiC particles with particle sizes between greater than or equal to 2 mm to 20 mm, or 5 mm to 63 mm, are achieved in all cases.

Advantageously, in the case of a temperature treatment of the SiC particles, this is carried out at temperatures between 2000° C. and 2600° C., more advantageously at temperatures of at least 2000° C. between 10 and 300 min.

Advantageously, the temperature treatment is likewise carried out under an argon or nitrogen atmosphere.

On the one hand, during the temperature treatment, silicon or silicon dioxide powders and carbon powders may be added to the particles made from the SiC waste products, through which an increase in the SiC content in the silicon carbide gravel according to the invention may be achieved.

Likewise, SiC powders with smaller particle sizes may also be added during the temperature treatment, which may then lead to a significant reduction of pores in the SiC powders made from the SiC waste products. This is particularly advantageous for waste made from raw SiC from the Acheson process. In doing so, it is possible to achieve a significant reduction in coarse pores from highly porous SiC powders with particle sizes of >2 mm made from raw SiC from the Acheson process with a low SiC content and/or poorly crystallized SiC (so-called beta SiC), by adding finer SiC powders and the further additives during the temperature treatment. As a result, these silicon carbide gravel particles have a high SiC content and exhibit good crystallization from so-called alpha-SiC.

If, after a temperature treatment according to the invention, a physical separation of the particles according to the invention is carried out, then, advantageously, this may be carried out according to the particle size, the particle shape, the density and/or the physical and/or chemical surface properties of the particles.

However, it is also possible if, after a temperature treatment according to the invention, and, in particular, after the treatment(s) of the novel SiC waste products with mechanical loading, a physical separation of the particles according to the invention into fractions is carried out, wherein, advantageously, such separation is carried out according to the particle size and/or particle shape by sieving, sifting and/or cyclone methods, or the separation is carried out by the action of mass forces with regard to the particle density by means of flotation, sedimentation, sifting, centrifugation and/or cyclone methods, or the separation is carried out according to the density of the particles by means of flotation and/or cyclone methods.

After a physical separation achieved according to the invention, the SiC powder is separated according to the invention into at least two fractions, wherein if a treatment of the SiC waste products under a mechanical loading has been carried out before a physical separation, a separation into at least two fractions is carried out, of which, in one fraction, the mass of impurities is at least a factor of 2 higher than in the other fraction.

The elimination of impurities in the form of Si and/or C is achieved by the temperature treatment, as carbon, advantageously, soot, graphite and/or coke powder, and/or silicon and/or silicon dioxide (SiO₂), which are added during the SiC production, may then be further converted to SiC and even added in order to achieve as stoichiometric a composition as possible.

Actual impurities for SiC are essentially metallic impurities, which accumulate in a fraction due to the physical separation after the temperature treatment and may therefore be eliminated easily.

Al and B are not [sic] as impurities in this [sic] in the production of raw SiC and also in the production of silicon carbide gravel according to the invention, as they are incorporated into the SiC lattice as doping elements and are not disruptive for most applications of SiC.

The impurities, for example, C_{free}, Si_{free}, SiO₂, and iron, as well as the SiC content are determined by known analysis methods, for example, according to DIN EN ISO 9286: 2021-10, DIN EN ISO 21068 Parts 1-3. Spectroscopic methods are also used for the analysis of impurities, DIN EN 15991, among others.

In the following, the invention is explained in more detail using a plurality of exemplary embodiments.

### EXAMPLE 1

100 kg of SSiC sintering scrap in lump form with an SiC content of 99.5% by mass is crushed using roller mills with metallic rollers with an energy input of 0.5 MJ/kg within 20 min. The resulting sharp-edged broken SSiC particles are sieved and a fraction having a particle size of >10 mm is separated with a yield of >80%, which is the silicon carbide gravel according to the invention.

The individual particles in this fraction have SiC contents of 99.5% by mass and have a density of 3.10 g/cm3, a compressive strength of 3200 MPa, a fraction of <0.1% of pores with an equivalent diameter of >100 μm and a fraction of open porosity of 0.1%.

The irregularly shaped particles have an average roundness of 0.6.

### EXAMPLE 2

200 kg of NSiC from refractory applications in lump form with a composition of SiC of 90% by mass, SiO₂ of 9.6% by mass and free fractions of C of 0.15% by mass, and Si of 0.14% by mass, and Fe of 0.128% by mass, is crushed using a jaw crusher with an energy input of 2 MJ/kg within 10 min. 79 g C per kg NSiC is added during the mechanical loading in the jaw crusher, such that a stoichiometric composition of the SiC waste product is achieved.

The mixed material is then treated at 2200° C. for a period of 300 min under vacuum.

Due to the partial sintering, the SiC particles are separated by pneumatic energy input of 1 MJ/kg in an autogenous mill and then fractionated by means of sifting. Irregularly shaped particles with sharp edges and partially rounded edges with a particle size of 2-5 mm are obtained with a yield of 90%.

The SiC particles that result from the process have an SiC content of >98% by mass and a density of 3.02 g/cm³, a compressive strength of 2850 MPa, a fraction of 2.3% pores with an equivalent diameter of >100 μm, and a fraction of open porosity of 3%. The irregularly shaped particles have an average roundness of 0.7.

### EXAMPLE 3

100 kg of jagged-coarse Si-SiC sintering scrap with a composition of 80% by mass SiC, 14% by mass Si, a free C fraction of 0.13% by mass, an SiO2 fraction of 3.97% by mass, and a Fe fraction of 0.968% by mass, and 33 kg of pyrolyzed mineral concrete waste with 65% by mass SiC and 30% by mass C and 5% by mass ash are crushed using a hammer mill with an energy input of 5 MJ/kg. The material then has an additional Fe concentration of 2 ma.-%.

The ground material is then treated at 2250° C. for a period of 40 min under argon atmosphere.

The particles are separated by pneumatic energy input of 2 MJ/kg in autogenous mills. During the subsequent wind screening, impurities accumulate in a fine fraction <500 μm. This fine fraction then has Fe and Si impurities [sic: >] 5% by mass.

The coarse fraction with particle sizes of 4 mm with a yield >95% has an SiC content of 98% by mass.

The irregularly shaped particles produced in doing so have sharp-edged and partially rounded edges, and a roundness of 0.75.

The partially sintered particles that result from the process have an SiC content of 98% by mass and a density of 2.95 g/cm³, a compressive strength of 2600 MPa, a fraction of 4% pores with an equivalent diameter of >100 μm, and a fraction of open porosity of 3%.

1. A silicon carbide gravel, whose particles consist of at least 85% by mass silicon carbide from SiC waste products and have a density of 2.89 to 3.20 g/cm3, a compressive strength of >2500 MPa, a fraction of <5% of pores with an equivalent diameter of >100 μm, and a fraction of open porosity of <10%, wherein the silicon carbide gravel consists at least predominantly of particles with particle sizes of greater than or equal to 2 mm and the particles have an irregular shape with a roundness of 0.5 to 0.8 produced by a mechanical loading with an energy input of between 0.1 and 5 MJ/kg.

2. The silicon carbide gravel according to claim 1, in which products from the Acheson process or SiC sintering scrap or manufacturing-related SiC waste from product manufacturing are present as SiC waste products, whose particles, which consist of at least 85% by mass silicon carbide and have a density of 2.89 to 3.20 g/cm3, a compressive strength of >2500 MPa, a fraction of <5% of pores with an equivalent diameter of >100 μm, and a fraction of open porosity of <10%, wherein the particles have at least predominantly particle sizes of greater than or equal to 2 mm and the particles have an irregular shape with a roundness of 0.5 to 0.8 produced by a mechanical loading with an energy input of between 0.1 and 5 MJ/kg

3. The silicon carbide gravel according to claim 2, in which such products made from SSiC, LPS-SiC, SiSiC, RSiC, NSiC and/or OBSiC ceramics and/or fiber composites from C-SiC and/or SiC-SiC are present as SiC waste products.

4. The silicon carbide gravel according to claim 1, which consists of at least 90% by mass, advantageously 95% by mass, more advantageously 98% by mass of silicon carbide.

5. The silicon carbide gravel according to claim 1, whose particles have a density of 3.05 to 3.20 g/cm3.

6. The silicon carbide gravel according to claim 1, which consists at least predominantly, advantageously at least 85%, more advantageously at least 95% of particles with a particle size greater than or equal to 2 mm.

7. The silicon carbide gravel according to claim 1, in which particle sizes between greater than or equal to 2 to 20 mm, or 5 mm to 63 mm, are present.

8. The silicon carbide gravel according to claim 1, which has particle shapes, which are achieved after a mechanical loading of the SiC waste products by applying a mechanical impulse, advantageously, by mixing, milling, more advantageously, by autogenous milling, or have been produced by using eddy currents and/or ultrasound, or by grinding, hammering, breaking or by electrical discharges or shock waves.

9. The silicon carbide gravel according to claim 1, which has irregular completely and/or partially sharp-edged and/or irregular completely or partially rounded particle shapes.

10. A method for the production of silicon carbide gravel, in which SiC waste products, except for SiC dust, are processed into SiC particles by mechanical loading with an energy input between 0.1 and 5 MJ/kg, which consist of at least 85% by mass of silicon carbide and have a density of 2.89 to 3.20 g/cm3, a compressive strength of >2500 MPa, a fraction of <5% of pores with an equivalent diameter of >100 μm, and a fraction of open porosity of <10%, and with particle sizes greater than or equal to 2 mm and an irregular shape with a roundness of 0.5 to 0.8,
or in which for the production of silicon carbide gravel, SiC waste products are processed into SiC particles before and/or after a temperature treatment under vacuum or non-oxidizing atmosphere at temperatures of 1400 to 2600° C. by mechanical loading with an energy input between 0.1 and 5 MJ/kg, which consist of at least 85% by mass of silicon carbide and have a density of 2.89 to 3.20 g/cm3, a compressive strength of >2500 MPa, a fraction of <5% of pores with an equivalent diameter of >100 μm, and a fraction of open porosity of <10%, and with particle sizes greater than or equal to 2 mm and an irregular shape with a roundness of 0.5 to 0.8,
or in which for the production of silicon carbide gravel, in which SiC waste products are processed into SiC particles before and/or after a temperature treatment under vacuum or non-oxidizing atmosphere at temperatures of 1400 to 2600° C. by mechanical loading with an energy input between 0.1 and 5 MJ/kg, which consist of at least 85% by mass of silicon carbide and have a density of 2.89 to 3.20 g/cm3, a compressive strength of >2500 MPa, a fraction of <5% of pores with an equivalent diameter of >100 μm, and a fraction of open porosity of <10%, and with particle sizes greater than or equal to 2 mm and an irregular shape with a roundness of 0.5 to 0.8, wherein such particles may be mechanically treated again, and at the same time or thereafter are physically separated into two fractions, of which the mass of impurities in one fraction is at least higher by a factor of 2 than in the other fraction.

11. The method according to claim 10, in which a physical separation of the SiC particles in fractions is carried out at least after one or the last treatment under mechanical loading of the SiC particles.

12. The method according to claim 10, in which SiC waste products are subjected to a temperature treatment under vacuum or non-oxidizing atmosphere at temperatures of 1400 to 2600° C., then a treatment under mechanical loading, and then a physical separation of the SiC particles in fractions.

13. The method according to claim 10, in which SiC waste products with a density of 3.05 to 3.20 g/cm3 are used.

14. The method according to claim 10, in which the mechanical loading of the SiC waste products is achieved by applying a mechanical impulse, advantageously by mixing, milling, more advantageously by autogenous milling, or by using eddy currents and/or ultrasound, or by milling, hammering, breaking or by electrical discharges or shock waves.

15. The method according to claim 10, in which particles with particle sizes greater than or equal to 2 mm to 20 mm, or 5 mm to 63 mm, are achieved.

16. The method according to claim 10, in which a temperature treatment is carried out at temperatures between 2000° C. and 2600° C.

17. The method according to claim 10, in which a temperature treatment is carried out under an argon or nitrogen atmosphere.

18. The method according to claim 10, in which a temperature treatment is carried out at temperatures of at least 2000° C. between 10 and 300 min.

19. The method according to claim 10, in which the physical separation of the particles after the temperature treatment is carried out according to the particle size, the particle shape, the density and/or the physical and/or chemical surface properties of the particles.

20. The method according to claim 10, in which the separation is carried out according to the particle size and/or particle shape by sieving, sifting and/or cyclone method, or the separation is carried out by the effect of mass forces with regard to particle density by flotation, sedimentation, sifting, centrifugation and/or cyclone method, or the separation is carried out according to the density of the particles by flotation and/or cyclone method.

21. A process using the silicon carbide gravel according to claim 1 for the production of SiC-containing ceramics, in particular refractory ceramics.
